(19) United States
(12) Patent Application Publication
(10) Pub. No.: US 2007/0218939 A1
(43) Pub. Date: Sep. 20, 2007

(54) System and method for supporting sleep mode operation in a wireless communication system

(75) Inventors: Hyoung-Kyu Lim, Seoul (KR); Pan-Yuh Joo, Seoul (KR); Jung-Je Son, Seongnam-si (KR); Jae-Weon Cho, Suwon-si (KR); Sung-Jin Lee, Seoul (KR); Hyun-Jeong Kang, Seoul (KR); Song-Nam Hong, Seoul (KR); Mi-Hyun Lee, Seoul (KR); Yeong-Moon Son, Anyang-si (KR); Young-Ho Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/712,130

(22) Filed: Feb. 28, 2007

(30) Foreign Application Priority Data
Feb. 28, 2006 (KR) 19666-2006

(51) Int. Cl. H04Q 7/20

(52) U.S. Cl. 455/528

(57) ABSTRACT

Disclosed is a method and system for performing a sleep mode operation in a wireless communication system. If there is a need to set a sleep interval of a receiver, a transmitter selects the sleep interval setting indicator for controlling sleep interval parameter setting, and transmits the selected sleep interval setting indicator to the receiver. A receiver receives from the transmitter a sleep interval setting indicator for controlling sleep interval parameter setting, and sets a sleep interval parameter according to the sleep interval setting indicator.

### PRIORITY

This application claims priority under 35 U.S.C. § 119(a) to a Korean Patent Application filed in the Korean Intellectual Property Office on Feb. 28, 2006 and assigned Serial No. 2006-19666, the disclosure of which is incorporated herein by reference.

### BACKGROUND OF THE INVENTION

1. Field of the Invention

The present invention relates generally to a communication system, and in particular, to a system and method supporting sleep mode operation in a wireless communication system.

2. Description of the Related Art

In the 4^{th} Generation (4G) communication system, which is the next generation communication system, research is being conducted to provide users with services having various Qualities of Service (QoS) at a high data rate. Particularly, in the 4G communication system, active research in high-speed services is being carried out in the way of guaranteeing mobility and QoS for a wireless communication system such as a wireless Local Area Network (LAN) system and a wireless Metropolitan Area Network (MAN) system.

The wireless communication system currently employs Orthogonal Frequency Division Multiplexing (OFDM)/Orthogonal Frequency Division Multiplex Access (OFDMA) in order to support a broadband transmission network for physical channels of the wireless MAN system.

However, because the wireless communication system takes mobility of a Mobile Station (MS) into account, power consumption of the mobile station serves as an important factor for the entire system. Therefore, a sleep mode and an awake mode operation between a mobile station and a Base Station (Base Station) have been proposed to minimize the power consumption of the mobile station.

With reference to FIG. 1, a description will now be made of a sleep mode operation of the wireless communication system.

FIG. 1 illustrates a sleep mode operation of a general wireless communication system.

Before a description of FIG. 1 is given, it should be noted that the sleep mode has been proposed to minimize power consumption of a mobile station in an idle interval where no packet data is transmitted. A mobile station and a BS simultaneously transition to the sleep mode, thereby minimizing power consumption of the mobile station in the idle interval where no packet data is transmitted.

Because packet data is generally generated on a burst basis, it is unreasonable for a BS and a mobile station to equally operate in both the packet transmission interval and the non-packet transmission interval. This is the reason why the sleep mode has been proposed. If the BS and the mobile station have transmission packet data while in the sleep mode, the BS and the mobile station should both transition to the awake mode and then exchange the packet data.

The sleep mode operation is also proposed as a scheme for minimizing not only the power consumption but also interference between channel signals. However, because a characteristic of the packet data is greatly affected by traffics, the sleep mode operation should be adaptively performed taking into account the traffic characteristic and transmission scheme of the packet data.

Referring to FIG. 1, reference numeral 111 shows a packet data generation pattern, which is comprised of a plurality of ON intervals and OFF intervals. The ON intervals are burst intervals where packet data, i.e. traffics, is generated, and the OFF intervals are idle intervals where no traffic is generated. The mobile station and the BS transition between the sleep mode and the awake mode according to the traffic generation pattern, thereby minimizing the power consumption of the mobile station and preventing interference between channel signals.

Reference numeral 113 shows the state transition (or mode change) pattern of the BS and the mobile station, and as shown an awake mode is followed by a sleep mode. The awake modes indicate the states in which traffics are generated, and in these states, actual packet data exchange between the BS and the mobile station is performed. However, the sleep modes indicate the states in which no traffic is generated, and in these states, actual packet data exchange between the BS and the mobile station is not performed.

Reference numeral 115 shows the MS power level pattern. As illustrated, the MS power level of the awake mode is defined as ‘K’, and the MS power level of the sleep mode is defined as ‘M’. The MS power level ‘M’ of the sleep mode is much lower than the MS power level ‘K’ of the awake mode (M<<K). Because there is no packet data exchange in the sleep mode, there is almost no power consumption in the sleep mode.

Before a description of the schemes currently proposed in the wireless communication system is given, the following preconditions will be described.

The mobile station should receive a state transition approval from the BS in order to make a state transition to the sleep mode. The BS should provide information indicating presence of packet data to be transmitted to the mobile station during a listening interval of the mobile station. Upon receipt of the information, the mobile station awakes from the sleep mode and determines whether there is any packet data to be transmitted from the BS to the mobile station itself. The listening interval is now described.

If it is determined that there is packet data to be transmitted from the BS to the mobile station itself, the mobile station makes a state transition to the awake mode and receives the packet data from the BS. However, if it is determined that there is no packet data to be transmitted from the BS to the mobile station itself, the mobile station can return to the sleep mode or stay in the awake mode.

A description will now be made of one example the schemes currently proposed in the wireless communication system to support the sleep mode operation. The messages defined in the wireless communication system to support the sleep mode operation and the awake mode operations are described.

(1) Sleep-Request (MOB_SLP-REQ) Message

The MOB_SLP-REQ message, transmitted from a mobile station to a BS, is a message used by the mobile station to request transition to the sleep mode. The MOB_SLP-REQ message includes therein parameters, i.e. Information Elements (IEs), required by the mobile station to operate in the sleep mode, and a format of the MOB_SLP-REQ message is shown in Table 1.

TABLE 1

| | Size | |
|---|---|---|
| Syntax | (bits) | Notes |
| MOB_SLP- | | |
| REQ_Message_format( ) { | | |
| Management message | 8 | |
| type=50 | | |
| Number of Classes | 8 | Number of power |
| | | saving classes. |
| for (i=0; i<Number of Classes; | | |
| i++) { | | |
| Definition | 1 | |
| Operation | 1 | |
| Power_Saving_Class_ID | 6 | |
| if(Operation=1) { | | |
| Start_frame_number | 6 | |
| Reserved | 2 | |
| } | | |
| if (Definition=1) { | | |
| Power_Saving_Class_Type | 2 | |
| Direction | 2 | |
| Traffic_triggered_wakening_flag | 1 | |
| reserved | 3 | |
| initial-sleep window | 8 | |
| listening-window | 8 | |
| final-sleep window base | 10 | |
| final-sleep window | 3 | |
| exponent | | |
| Number_of_Sleep_CIDs | 3 | |
| for(i=0;i<Number_of_Sleep_CIDs;i++ | | |
| { | | |
| CID | 16 | |
| } | | |
| } | | |
| TLV encoded information | variable | |
| } | | |

A definition of IEs of the MOB_SLP-REQ message is given below.

‘Management message type’ is information indicating a type of the currently transmitted message, and ‘Management message type’=50 indicates the MOB_SLP-REQ message. ‘Number of Classes’ indicates the number of power saving classes to be included in the MOB_SLP-REQ message. ‘Definition’ indicates whether the mobile station defines a new power saving class or indicates an operation of the previously defined power saving class. ‘Operation’ indicates whether the mobile station activates or deactivates the power saving class. ‘Power_Saving_Class_ID’ is an identifier for designating a power saving class indicating the currently defined operation. ‘Start_frame_number’ indicates the time the mobile station will activate the corresponding power saving class.

‘Power_Saving_Class_Type’ indicates a type of the corresponding power saving class, and this designates one of the three types defined in the wireless communication system. ‘Type 1’ indicates a class based on the sleep mode operation, and ‘Type 2’ is equal to ‘Type 1’ except that the size of the sleep interval remains at an ‘initial-sleep window’ value and the mobile station continuously keeps the sleep mode unless it does not receive a message or header for explicitly deactivating the sleep mode even though it fails to receive a Traffic-Indication (MOB_TRF-IND) message in the listening interval. ‘Type 3’ is not dealt with in the application, so the description thereof is omitted.

‘Direction’ indicates whether the corresponding message is for an uplink (UL) or a downlink (DL). ‘Traffic_triggered_wakening_flag’ is applied only to ‘Type 1’, and indicates whether to deactivate the sleep mode in the following three situations: (i) when the BS transmits a MAC SDU for the corresponding power saving class or a part of it in the listening interval, (ii) when the mobile station requests a bandwidth for a connection for the corresponding power saving class, and (iii) when the mobile station receives a MOB_TRF-IND message with a positive indication. ‘Traffic_triggered_wakening_flag’=0 indicates that the mobile station should not deactivate the sleep mode even though any one of the above three situations occurs. ‘Traffic_triggered_wakening_flag’=1 indicates that the mobile station should deactivate the sleep mode and transition to the awake mode if any one of the above three situations occurs.

A value of ‘initial-sleep window’ indicates a start setting value required for the sleep interval, and ‘listening window’ indicates a required listening interval. The maximum value of the sleep interval is determined using two parameters: one is ‘final-sleep window base’ and another is ‘final-sleep window exponent’. The maximum sleep window value is defined as ‘final-sleep window base’*2^{‘final-sleep window exponent’}.

‘Number_of Sleep_CIDs’ indicates the number of unicast CIDs associated with the corresponding power saving class.

(2) Sleep-Response (MOB_SLP-RSP) Message

The MOB_SLP-RSP Message, a response message to the MOB_SLP-REQ message, can be used as a message indicating whether to approve or reject the state transition to the sleep mode, requested by the mobile station, or can be used as a message indicating unsolicited instruction. The MOB_SLP-RSP Message includes therein the IEs required by the mobile station to operate in the sleep mode, and a format of the MOB_SLP-RSP Message is shown in Table 2.

TABLE 2

| | Size | |
|---|---|---|
| Syntax | (bits) | Notes |
| MOB_SLP-RSP_Message_format( ) | | |
| { | | |
| Management message type=51 | 8 | |
| Number of Classes | 8 | Number of |
| | | power saving |
| | | classes. |
| for (i=0; i<Number_of_Classes; | | |
| i++) { | | |
| Length of Data | 7 | |
| Sleep Approved | 1 | |
| Definition | 1 | |
| Operation | 1 | |
| Power_Saving_Class_ID | 6 | |
| if(Sleep Approved==1) { | | |
| if(Operation = 1) { | | |
| Start_frame_number | 6 | |
| Reserved | 2 | |
| } | | |
| if (Definition=1) { | | |
| Power_Saving_Class_Type | 2 | |
| Direction | 2 | |
| initial-sleep window | 8 | |
| listening-window | 8 | |
| final-sleep window base | 10 | |
| final-sleep window | 3 | |
| exponent | | |
| TRF-IND required | 1 | |
| Traffic_triggered_wakening_flag | 1 | |
| Reserved | 1 | |
| if(TRF-IND required) { | | |
| SLPID | 10 | |
| Reserved | 2 | |
| } | | |
| Number_of_CIDs | 4 | |
| for(i=0;i<Number_of_CIDs;i++) { | | |
| CID | 16 | |
| } | | |
| if(MDHO or FBSS | | If MDHO or FBSS |
| capability enabled) { | | capability is enabled |
| | | in the REG-REQ/ |
| | | RSP message |
| | | exchange. |
| Maintain Diversity Set | 1 | |
| and Anchor BS | | |
| if(Maintain Diversity Set | | |
| and Anchor BS) { | | |
| MDHO/FBSS | 3 | |
| duration(s) | | |
| } | | |
| } | | |
| } | | |
| Padding | variable | If needed for |
| | | alignment to byte |
| | | boundary |
| if(Operation = 1) { | | |
| Power Saving Class TLV | variable | |
| encoded information | | |
| } | | |
| } else { | | In case Sleep |
| | | Approved == 0 |
| REQ-DURATION | 8 | |
| } | | |
| TLVencoded information | variable | |
| } | | |

The MOB_SLP-RSP Message is also a dedicated message transmitted based on a basic CID of the mobile station, and a definition of the IEs of the MOB_SLP-RSP Message shown in Table 2 is given below.

‘Management message type’ is information indicating a type of the currently transmitted message, and ‘Management message type’=51 indicates the MOB_SLP-RSP Message. ‘Length_of Data’ indicates the number of bytes of a power saving class described below. A value of ‘Sleep_Approved’ indicates whether to approve or reject an activation/deactivation request for the corresponding power saving class of the mobile station. For ‘Sleep_Approved’=‘1’, if ‘Operation’=‘1’ (activation), the message includes ‘Start_frame_number’, and if ‘Definition’=‘1’, the message includes ‘Power_Saving_Class_Type’, ‘Direction’, ‘initial-sleep window’, ‘listening window’, ‘final-sleep window base’, ‘final-sleep window exponent’, ‘TRF-IND required’, and ‘Traffic_triggered_wakening_flag’. The ‘TRF-IND required’ is applied only to ‘Type 1’ of the power saving class, and indicates that the BS should transmit at least one MOB_TRF-IND message every listening interval.

(3) Traffic-Indication (MOB_TRF-IND) Message

The MOB_TRF-IND message, transmitted from a BS to a mobile station for the listening interval, is a message indicating that the BS has packet data to transmit to the mobile station. A format of the MOB_TRF-IND message is shown in Table 3.

TABLE 3

| Syntax | Size (bits) | Notes |
|---|---|---|
| MOB_TRF- | | |
| IND_Message_format( ) { | | |
| Management message | 8 | |
| type=52 | | |
| FMT | 1 | |
| if(FMT==0) { | | |
| SLPID Group | 32 | Nth bit of SLPID-Group |
| Indication bit-map | | indication bit-map [MSB corresponds to |
| | | N = 0] is allocated to SLPID Group that |
| | | includes MS with SLPID values from |
| | | N * 32 to N * 32 + 31 |
| | | Meaning of this bit |
| | | 0: There is no traffic for all the |
| | | 32 MS which belong to the SLPID- |
| | | Group |
| | | 1: There is traffic for at least one |
| | | MS in SLPID-Group. |
| Traffic Indication | variable | Traffic Indication bit map |
| Bitmap | | comprises the multiples of 32-bit long |
| | | Traffic Indication unit. |
| | | A Traffic Indication unit for 32 |
| | | SLPIDs is added to MOB_TRF-IND |
| | | message whenever its SLPID Group is |
| | | set to 1 32 bits of Traffic Indication Unit |
| | | (starting from MSB) are allocated to MS in |
| | | the ascending order of their SLPID values: |
| | | 0: Negative indication |
| | | 1: Positive indication |
| } else { | | |
| Num_Pos | 8 | Number of CIDs following |
| for (i=0; i<Num_Pos; | | |
| i++) { | | |
| SLPIDs | 10 | |
| } | | |
| } | | |
| Padding | variable | If needed, for alignment to byte |
| | | boundary. |
| TLV encoded items | variable | |
| } | | |

The MOB_TRF-IND message, unlike the MOB_SLP-REQ message and the MOB_SLP-RSP Message, is transmitted through a Broadcast CID or a Sleep mode multicast CID on a broadcasting or multicasting basis. The MOB_TRF-IND message is a message indicating whether there is any packet data that the BS will transmit to a specific mobile station, and the mobile station decodes the MOB_TRF-IND message for the listening interval and then determines whether it will transition to the awake mode or return to the sleep mode.

If the mobile station determines to transition to the awake mode, the mobile station checks frame synchronization, and if its expected frame sequence number is mismatched, the mobile station can request retransmission of the lost packet data in the awake mode. However, if the mobile station has failed to receive the MOB_TRF-IND message for the listening interval, or if the MOB_TRF-IND message indicates negative indication even though the mobile station has received the MOB_TRF-IND message, the mobile station can return to the sleep mode.

A definition of the IEs of the MOB_TRF-IND message shown in Table 3 is given below.

‘Management message type’ is information indicating a type of the currently transmitted message, and ‘Management message type’=52 indicates the MOB_TRF-IND message. ‘FMT’ indicates whether the format of the MOB_TRF-IND message indicates use of an SLPID bit-map format or use of an SLPID format. When the SLPID bit-map format is used, the bit-map is comprised of two hierarchical bit-maps: one is an SLPID Group Indication bit-map and another is a Traffic Indication bit-map. An SLPID group is composed of 32 SLPIDs, and there are a total of 32 SLPID groups. One bit of the SLPID Group Indication bit-map is allocated per group, and indicates if the corresponding group has more than one SLPID with positive indication. For each SLPID group with a value ‘1’, one Traffic Indication bit-map is included, and each bit of the Traffic Indication bit-map indicates positive/negative indication of the corresponding SLPID. However, when the SLPID format is used, the number of SLPIDs indicating positive indication, and the SLPIDs are included.

(4) DL Sleep Control Extended Subheader

The DL Sleep control extended subheader is an extended subheader that a BS transmits to a mobile station to activate/deactivate a specific power saving class, and the format thereof is shown in Table 4.

TABLE 4

| | Size | |
|---|---|---|
| Name | (bits) | Description |
| Power_Saving_Class_ID | 6 | Power Saving Class ID this |
| | | command refers to. |
| Operation | 1 | 1 = activate Power Saving |
| | | Class |
| | | 0 = de-activate Power |
| | | Saving Class |
| Final_Sleep_Window_Exponent | 3 | For Power Saving Class |
| | | Type III only: assigned factor |
| | | by which the final-sleep |
| | | window base is multiplied |
| | | in order to calculate the |
| | | duration of single sleep |
| | | window requested by the |
| | | message. |
| Final_Sleep_Window_Base | 10 | For Power Saving Class |
| | | Type III only: the base for |
| | | duration of single sleep |
| | | window requested by the |
| | | message. |
| Reserved | 4 | |

The IEs of the DL Sleep control extended subheader shown in Table 4 are equal to those of the MOB_SLP-RSP Message, so the description thereof is omitted.

The messages defined in the wireless communication system to support the sleep mode operation and the awake mode operation have been described above.

In the wireless communication system, the ‘Traffic_triggered_wakening_flag’ remains with the value negotiated during in the initial MOB_SLP-REQ/MOB_SLP-RSP transaction. However, during the sleep mode operation, there may be a need to change the ‘Traffic_triggered_wakening_flag’ according to the change of traffic pattern.

In addition, if the type of the power saving class is ‘Type 1’ in the sleep mode operation of the wireless communication system, the mobile station can determine whether to deactivate the sleep mode based on the ‘Traffic_triggered_wakening_flag’, setting (i) when the mobile station receives a MAC SDU or a part of it from the BS in the listening interval, (ii) when the mobile station sends a bandwidth request to the BS, and (iii) when the mobile station receives a MOB_TRF-IND message with positive indication from the BS. However, there is no clear description of how to set the sleep interval when the mobile station maintains the sleep mode even after the end of the corresponding listening interval.

### SUMMARY OF THE INVENTION

An aspect of the present invention is to at least address the above problems and/or disadvantages and to provide at least the advantages described below. Accordingly, an aspect of the present invention is to provide a sleep mode operation system and method for determining when to activate the sleep mode in a wireless communication system.

Another aspect of the present invention is to provide a sleep mode operation system and method for setting the sleep interval time during the sleep mode operation in a wireless communication system.

A further aspect of the present invention is to provide a sleep mode operation system and method for effectively controlling the operation of a mobile station while in sleep mode by reconfiguring the sleep interval and related parameters.

According to one aspect of the present invention, there is provided a method for controlling the sleep mode operation in a transmitter of a wireless communication system. The method includes selecting the sleep interval setting indicator for controlling sleep interval parameter setting, if there is a need to set a sleep interval of a receiver; and transmitting the selected sleep interval setting indicator to the receiver.

According to another aspect of the present invention, there is provided a method for performing a sleep mode operation in a receiver of a wireless communication system. The method includes receiving from a transmitter a sleep interval setting indicator for controlling sleep interval parameter setting; and setting a sleep interval parameter according to the sleep interval setting indicator.

According to a further aspect of the present invention, there is provided a system for performing a sleep mode operation in a wireless communication system. The system includes a transmitter for selecting a sleep interval setting indicator for controlling sleep interval parameter setting, if there is a need to set a sleep interval of a receiver, and transmitting the selected sleep interval setting indicator to the receiver.

According to yet another aspect of the present invention, there is provided a system for performing a sleep mode operation in a wireless communication system. The system includes a receiver for receiving from a transmitter a sleep interval setting indicator for controlling sleep interval parameter setting, and setting a sleep interval parameter according to the sleep interval setting indicator.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a sleep mode operation of a general wireless communication system;

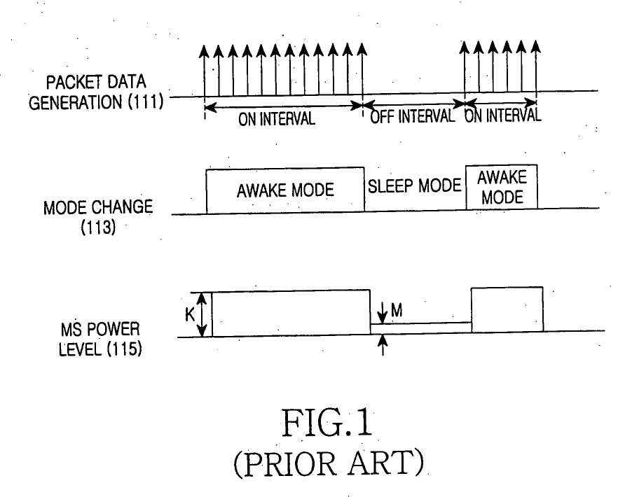

FIG. 2 is a flowchart for a sleep mode operation of a BS in a wireless communication system according the present invention;

FIG. 3 is a flowchart for a sleep mode operation of a BS in a wireless communication system according to the present invention;

FIG. 4 is a flowchart for a sleep mode operation of a mobile station in a wireless communication system according to the present invention;

FIG. 5 is a flowchart of a mobile station operation for setting sleep interval parameters based on ‘Sleep_interval_option’ in a wireless communication system according to the present invention; and

FIG. 6 is a flowchart of a mobile station operation for setting activation/deactivation of a sleep mode operation in a wireless communication system according to the present invention.

### DETAILED DESCRIPTION OF EXEMPLARY EMBODIMENTS

Exemplary embodiments of the present invention will now be described in detail with reference to the annexed drawings. In the following description, detailed description of known functions and configurations incorporated herein has been omitted for clarity and conciseness.

The present invention provides a sleep mode operation for setting the sleep interval depending on activation of the sleep mode operation between a transmitter and a receiver, for example, a Base Station (BS) and a Mobile Station (MS), in a wireless communication system. The transmitter selects a sleep interval setting indicator and transmits the selected sleep interval setting indicator to the receiver, and the receiver sets sleep interval parameters according to the sleep interval setting indicator. The transmitter and the receiver can determine activation/deactivation of the sleep mode by exchanging a flag setting used for determining activation/deactivation of the sleep mode.

Before a description of the sleep mode operation is given, parameters required for supporting the sleep mode and awake mode operations will now be described briefly herein below.

First, a Sleep Identifier (SLPID), a number that a mobile station is allocated through a MOB_SLP-RSP message in a process of transitioning to the sleep mode, is unique only to the mobile stations existing in the sleep mode. That is, the SLPID is used for distinguishing the mobile stations in the sleep mode state including a listening interval.

Second, a sleep interval, an interval that a mobile station requests and a BS can allocate in response to the request of the mobile station, indicates a time interval in which the mobile station transitions to the sleep mode and then keeps the sleep mode until the listening interval starts. That is, the sleep interval is defined as a time for which the mobile station remains in the sleep mode. The mobile station can remain in the sleep mode when there is no data to be transmitted from the BS to the mobile station even after the sleep interval. In this case, the mobile station increases and updates a size of the sleep interval using preset ‘initial-sleep window’ and ‘final-sleep window’. The ‘initial-sleep window’ value indicates the minimum initial limit of the sleep interval, and the ‘final-sleep window’ value indicates the maximum value of the sleep interval. For example, the ‘initial-sleep window’ value and the ‘final-sleep window’ value can be expressed with the number of frames.

The listening interval, which is an interval that a mobile station requests and a BS can allocate in response to the request of the mobile station, indicates the time interval in which the mobile station temporarily awakes from the sleep mode, matches its synchronization to a downlink signal of the BS, and then receives downlink messages, for example, a MOB_TRF-IND message with traffic indication. The MOB_TRF-IND message is a message indicating whether there is any traffic message, i.e. packet data, to be transmitted to the mobile station, and a detailed description thereof has been given above.

The mobile station waits for the MOB_TRF-IND message during the listening interval, and if a bit included in the MOB_TRF-IND message indicating the mobile station in the SLPID bit-map is set to ‘1’, the mobile station remains in the awake mode. On the contrary, if the bit indicating the mobile station in the SLPID bit-map included in the MOB_TRF-IND message is set to ‘0’, the mobile station transitions back to the sleep mode.

Third, the sleep interval update algorithm will be described below. If the mobile station transitions to the sleep mode, it determines the sleep interval, considering a preset minimum window value as a minimum sleep mode period. Thereafter, the mobile station awakes from the sleep mode for the listening interval, determines that there is no packet data to be transmitted from the BS, sets the sleep interval to a value which is two times the previous sleep interval, and then remains in the sleep mode. For example, if the minimum window value was ‘2’, the mobile station sets the sleep interval to a two-frame interval, and then remains in the sleep mode for the two frames. After the two frames lapse, if the mobile station awakes from the sleep mode and receives a MOB_TRF-IND message with negative indication, i.e. if the mobile station determines that there is no packet data transmitted from the BS to the mobile station, the mobile station sets the sleep interval to a four-frame interval which is two times the two-frame interval, and then remains in the sleep mode for the four frames. The increase in the sleep interval is possible between the minimum widow value and the maximum window value.

The messages defined in the wireless communication system to support the sleep mode operation and the awake mode operation have been described above, and the present invention will now be described with reference to the messages.

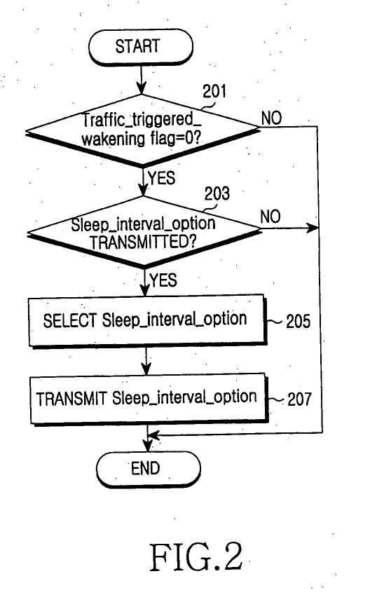

FIG. 2 is a flowchart schematically illustrating a BS operation for a sleep mode operation of a mobile station in a wireless communication system according to an embodiment of the present invention.

Referring to FIG. 2, a BS determines in step 201 whether a ‘Traffic_triggered_wakening_flag’ is set to ‘0’. The ‘Traffic_triggered_wakening_flag’ is a flag used for determining whether the sleep mode is activated, and activation/deactivation of the sleep mode is determined according to the flag value=‘0’ or ‘1’.

If it is determined that the ‘Traffic_triggered_wakening_flag’ is not set to ‘0’ but to ‘1’, the BS operates in the existing way. It will be considered herein that the ‘Traffic_triggered_wakening_flag’ is set to ‘0’.

However, if it is determined that the ‘Traffic_triggered_wakening_flag’ is set to ‘1’, the BS proceeds to step 203.

In step 203, the BS determines if it should transmit ‘Sleep_interval_option’. The ‘Sleep_interval_option’ is a sleep interval indicator for sleep interval setting, and the present invention uses, for example, a 2-bit ‘Sleep_interval_option’. The ‘Sleep_interval_option’ described herein is given by way of example, and another sleep interval indicator composed of a different number of bits in a different form can also be used.

With reference to Table 5, the ‘Sleep_interval_option’ used for determining the length of the sleep interval will now be described.

TABLE 5

| Syntax | Size | Notes |
|---|---|---|
| Sleep_interval_option | 2 bits | 00: continue |
| | | 01: reset to the initial value |
| | | 10: continue with renewed value |
| | | 11: freeze with the latest value |

Table 5 shows a parameter value for sleep interval setting according to configuration of bit value of the ‘Sleep_interval_option’.

First, the BS uses ‘Sleep_interval_option’=‘00’, when it intends not to change the parameter for current sleep interval setting of the mobile station, i.e. allows the sleep interval update algorithm not to change the parameter.

If the BS sets the ‘Sleep_interval_option’ to ‘00’, it enables the sleep mode operation without a separate parameter change. Therefore, the BS uses the ‘Sleep_interval_option’=‘00’, when the mobile station operates as if it has received a MOB_TRF-IND message with negative indication meaning that the mobile station will not receive data, i.e. specifically, when the BS determines that there is a very low possibility that traffics for the mobile station will be further generated later, considering that the current data traffics have been temporarily stopped.

Second, the BS uses a ‘Sleep_interval_option’=‘01’, when it intends to set the current sleep interval parameter of the mobile station to an initial value, i.e. allows the sleep interval update algorithm to set the parameter to an initial value.

If the BS sets the ‘Sleep_interval_option’ to ‘01’, the mobile station operates back in the sleep mode using the parameter negotiated through the MOB_SLP-REQ/RSP messages between the mobile station and the BS.

Third, the BS uses ‘Sleep_interval option’=‘10’, when it intends to set the current sleep interval parameter of the mobile station to a new value, i.e. allows the sleep interval update algorithm to set the parameter to a new value. When the BS sets the ‘Sleep_interval_option’ to ‘10’, it transmits a new parameter for sleep interval setting to the mobile station to determine the length of the sleep interval, or enables the sleep interval update algorithm.

Fourth, the BS uses ‘Sleep_interval_option’=‘11’, when it intends to set the parameter for current sleep interval setting of the mobile station to the latest value, i.e. allows the sleep interval update algorithm to set the parameter to the latest value. When the BS sets the ‘Sleep_interval option’ to ‘11’, it allows the mobile station to continuously use the parameter value for sleep interval so that the mobile station may maintain the current sleep window value even when the sleep window has not arrived at its maximum value.

If it is determined in step 203 that it does not transmit the ‘Sleep_interval_option’, the BS ends the operation. However, if it is determined that it transmits the ‘Sleep_interval_option’, the BS proceeds to step 205.

In step 205, the BS selects a ‘Sleep_interval_option’ value for sleep interval setting according to the value shown in Table 5, and then proceeds to step 207.

In step 207, the BS transmits the ‘Sleep_interval_option’ to the mobile station. If the ‘Sleep_interval_option’ is ‘10’, the BS transmits the ‘Sleep_interval_option’ along with the parameters for sleep interval setting.

The BS can transmit the ‘Sleep_interval_option’ using various messages associated with the sleep mode, and the messages used for transmitting the ‘Sleep_interval_option’ are given below by way of example.

1) MOB_SLP-RSP Message (MOB_SLP-REQ Message)

The BS and the mobile station transmit/receive the ‘Sleep_interval_option’ using the MOB_SLP-REQ message and the MOB_SLP-RSP message when they are negotiating over a sleep mode operation. The ‘Sleep_interval option’ is applied when a value of the ‘Traffic_triggered_wakening_flag’ is ‘0’, and the mobile station sets a sleep interval parameter according to the ‘Sleep_interval_option’.

2) MOB_TRF-IND Message

The MOB_TRF-IND Message is a message broadcasted from the BS to each mobile station. The BS transmits the ‘Sleep_interval option’ along with the MOB_TRF-IND message. Herein, all mobile stations with ‘Traffic_triggered_wakening_flag’=‘0’ among the mobile stations receiving positive indication, set a sleep interval based on ‘Sleep_interval_option’ in the MOB_TRF-IND message. However, if the BS transmits an SLPID and a power saving class ID (Power_Saving_Class_ID) together in the MOB_TRF-IND message, it can apply the ‘Sleep_interval_option’ in a particular power saving class for a particular mobile station. With reference to Table 6, a description will now be made of the Type/Length/Value (TLV) for applying the ‘Sleep_interval_option’ to a particular mobile station.

TABLE 6

| Type | Length | Value |
|---|---|---|
| Sleep_interval_control_1 | 24 bits | bit #1-#9: SLPID |
| | | bit #10-#15: |
| | | Power_Saving_Class_ID |
| | | bit #16-#17: |
| | | Sleep_interval_option |
| | | bit #18-#23: reserved |

Table 6 shows TLV for a 24-bit sleep interval control (Sleep_interval_control_{—}1), to which ‘SLPID’, ‘Power_Saving_Class_ID’, ‘Sleep_interval_option’ and ‘reserved’ are allocated.

3) DL Sleep Control Extended Subheader

The BS transmits the ‘Sleep_interval option’ to each mobile station along with the DL Sleep control extended subheader. In this case, the BS uses the reserved bits unused in the DL Sleep control extended subheader. Alternatively, the BS can transmit the ‘Sleep_interval_option’ to each mobile station using an extended subheader having a different format. With reference to Table 7, a description will now be made of IEs included in the extended subheaders.

TABLE 7

| Name | Size | Description |
|---|---|---|
| Power_Saving_Class_ID | 24 bits | Power_Saving_Class_ID, to |
| | | which a reference is made by |
| | | this instruction. |
| Sleep_interval_option | 2 bits | Sleep interval option applied to |
| | | corresponding |
| | | Power_Saving_Class_ID |

Table 7 shows ‘Power_Saving_Class_ID’ and ‘Sleep_interval_option’, which are the IEs included in the extended subheaders.

If the ‘Sleep_interval_option’ is ‘01’ in step 207, the parameters for sleep interval setting, transmitted from the BS to the mobile station, include 8-bit ‘initial-sleep window’, 8-bit ‘listening window’, 10-bit ‘final-sleep window base’, and 3-bit ‘final-sleep window exponent’ parameters.

Therefore, the BS and the mobile station, when the MOB_SLP-RSP Message (MOB_SLP-REQ message) transmits ‘Sleep_interval_option’=‘10’, transmit the parameter values along with the MOB_SLP-RSP Message (MOB_SLP-REQ message). When the BS transmits the ‘Sleep_interval_option’ or the parameters to the mobile station, it uses the MOB_SLP-RSP Message. On the contrary, when the mobile station transmits the ‘Sleep_interval_option’ or the parameters to the BS, it uses the MOB_SLP-REQ message.

In addition, when the BS uses the MOB_TRF-IND message, it can make another separate TLV with the parameters and add it to the message, and an extended TLV of Table 6 can be used for this. With reference to Table 8, a description will now be made of a second sleep interval control (Sleep_interval_control_{—}2) obtained by extending the first sleep interval control (Sleep_interval_control_{—}1) of Table 6.

TABLE 8

| Type | Length | Value |
|---|---|---|
| Sleep_interval_control_2 | 48 bits | bit #1-#9: SLPID |
| | | bit #10-#15: |
| | | Power_Saving_Class_ID |
| | | bit #16-#17: |
| | | Sleep_interval_option |
| | | bit #18-#25: initial-sleep |
| | | window |
| | | bit #26-#33: listening window |
| | | bit #34-#43: final-sleep window |
| | | base |
| | | bit #44-#46: final-sleep window |
| | | exponent |
| | | bit #47: reserved |

The second sleep interval control TLV (Sleep_interval_control_{—}2) of Table 8 includes ‘SLPID’, ‘Power_Saving_Class_ID’, ‘Sleep_interval_option’, ‘initial-sleep window’, ‘listening window’, ‘final-sleep window base’, ‘final-sleep window exponent’, and ‘reserved’ parameters. The use of the extended TLV shown in Table 8, compared with the use of the separate TLV for the parameters, can decrease a length of the TLV by one byte.

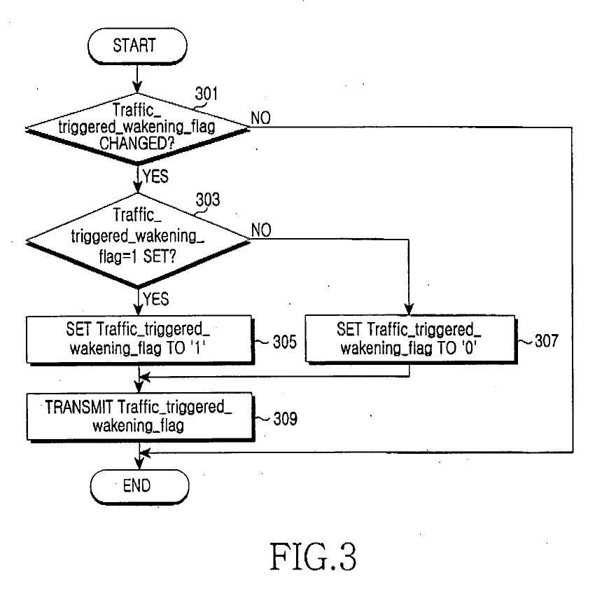

When the BS uses the above extended subheaders, it can add the parameters described in Table 8 to Table 7 as IEs, and transmit them to the mobile station. With reference to FIG. 3, a description will now be made of a BS operation of determining whether to activate the sleep mode using the ‘Traffic_triggered_wakening_flag’.

Referring to FIG. 3, a BS determines in step 301 if there is any change in ‘Traffic_triggered_wakening_flag’. The ‘Traffic_triggered_wakening_flag’ is a flag used for determining if the sleep mode is activated, and activation/deactivation of the sleep mode is determined according to the flag setting=‘0’ or ‘1’.

The ‘Traffic_triggered_wakening_flag’ is included in the MOB_SLP-REQ message and the MOB_SLP-RSP Message, and when the BS and the mobile station initially enter the sleep mode, the ‘Traffic_triggered_wakening_flag’ is set through negotiation between the BS and the mobile station using the MOB_SLP-REQ/RSP messages.

However, when the BS transmits data to a mobile station operating in the sleep mode, it can transmit all the data only using the listening interval, or cannot transmit all the data only within the listening interval. In this way, there may be a need for a change in the listening interval and the sleep interval according to time and size of the data. Conventionally, however, when the ‘Traffic_triggered_wakening_flag’ is set to ‘0’, the mobile station cannot deactivate the sleep mode even though it receives the MOB_TRF-IND message in the listening interval. Therefore, the BS determines if it should change the ‘Traffic_triggered wakening_flag’.

If it is determined that there is no need to change the ‘Traffic_triggered_wakening_flag’, the BS ends the operation. However, if there is a need to change the ‘Traffic_triggered wakening_flag’, the BS proceeds to step 303.

In step 303, the BS determines whether it should set the ‘Traffic_triggered_wakening_flag’ to ‘1’. Even when the mobile station should be deactivated in terms of the sleep mode, if it is determined that the BS intends to set the ‘Traffic_triggered_wakening_flag’ to ‘0’ so that the mobile station cannot be deactivated, the BS proceeds to step 307.

In step 307, the BS sets the ‘Traffic_triggered_wakening_flag’ to ‘0’, and then proceeds to step 309.

However, when the mobile station should be deactivated in terms of the sleep mode, if it is determined that the BS intends to set the ‘Traffic_triggered_wakening_flag’ to ‘1’ so that the mobile station can deactivate the sleep mode and transition to the awake mode, the BS proceeds to step 305.

In step 305, the BS sets the ‘Traffic_triggered_wakening_flag’ to ‘1’, and then proceeds to step 309.

In step 309, the BS transmits the set ‘Traffic_triggered_wakening_flag’ to the mobile station. Herein, when the ‘Traffic_triggered_wakening_flag’ is set to ‘0’, the BS should necessarily deactivate the sleep mode through the MOB_TRF-IND message in order to deactivate the sleep mode. However, it is also possible to allow the BS to change the ‘Traffic_triggered_wakening_flag’ in the listening interval, so that the BS can dynamically control the sleep mode operation of the mobile station according to data traffic.

In addition, the BS can use the following two methods for the change in the ‘Traffic_triggered_wakening_flag’.

A first method transmits the ‘Traffic_triggered wakening_flag’ along with the MOB_TRF-IND message in the listening interval of the mobile station. Alternatively, the first method transmits the TLV along with the MOB_TRF-IND message. With reference to Table 9, a description will now be made of TLV including the ‘Traffic_triggered_wakening_flag’.

TABLE 9

| Type | Length | Value |
|---|---|---|
| Sleep_interval_control_2 | 48 bits | bit #1-#9: SLPID |
| | | bit #10-#15: |
| | | Power_Saving_Class_ID |
| | | bit #16-#17: |
| | | Sleep_interval_option |
| | | bit #18-#25: initial sleep window |
| | | bit #26-#33: listening window |
| | | bit #34-#43: final-sleep window |
| | | base |
| | | bit #44-#46: final-sleep window |
| | | exponent |
| | | bit #47: |
| | | Traffic_triggered_wakening_flag |

The TLV shown in Table 9 is included in the MOB_TRF-IND message, and is a modified TLV of Table 8.

A second method uses a DL Sleep control extended subheader. The second method can transmit the ‘Traffic_triggered_wakening_flag’ using one ‘reserved’ bit of the DL Sleep control extended subheader shown in Table 4, or can transmit the ‘Traffic_triggered_wakening_flag’ using one bit added to the DL Sleep control extended subheader proposed in Table 7.

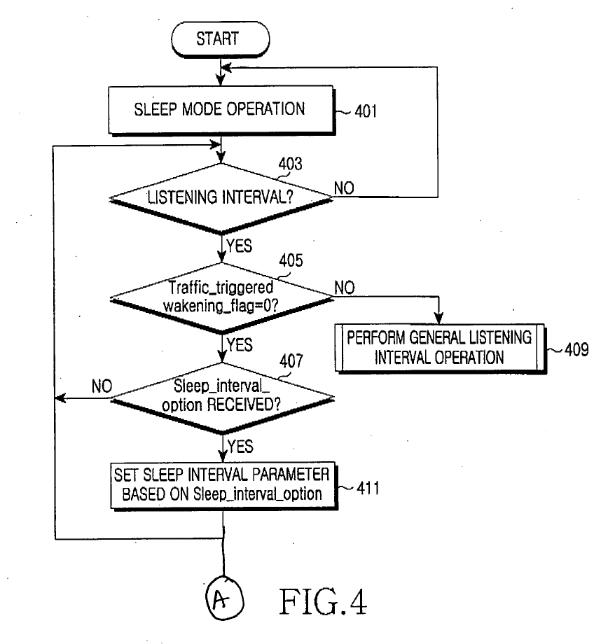

The BS operation according to of the present invention has been described so far. With reference to FIG. 4, a description will now be made of a sleep mode operation of the mobile station.

Referring to FIG. 4, a mobile station performs a sleep mode operation in step 401, and then proceeds to step 403.

In step 403, the mobile station determines whether it is in a listening interval. If it is determined that the mobile station is not in the listening interval, the mobile station returns to step 401 as it is in the sleep mode. However, if it is determined that the mobile station is in the listening interval, the mobile station determines in step 405 whether ‘Traffic_triggered_wakening_flag’ is set to ‘0’.

If it is determined that the flag value is ‘1’, the mobile station proceeds to step 409 where it performs a general listening interval operation. Upon receiving downlink data including MOB_SLP-RSP message, sleep interval extended subheader, and MOB_TRF-IND message in the listening interval, the mobile station immediately leaves the sleep mode and transitions to the awake mode, performing the general listening interval operation.

However, if it is determined that the flag value is ‘0’, the mobile station proceeds to step 407 where the mobile station keeps the sleep mode state even though it receives the downlink data. Therefore, the mobile station proceeds to step 407 in order to reset the length of the sleep interval after expiration of the current listening interval.

In step 407, the mobile station determines if it has received a ‘Sleep_interval_option’. If it is determined that it has failed to receive the ‘Sleep_interval_option’, the mobile station returns to step 403 and continues the listening interval operation. However, if it is determined that it has received the ‘Sleep_interval_option’, the mobile station proceeds to step 411.

In step 411, the mobile station sets the parameter corresponding to the ‘Sleep_interval_option’, and then returns to step 403. If the ‘Sleep_interval_option’ is set to ‘10’, the mobile station determines if it has received a new parameter. If it has received new parameter values, the mobile station sets a sleep interval, i.e. sets parameters of a sleep interval update algorithm, using the received parameter values.

The description of FIG. 4 has been made using the operation of transmitting the management messages such as MOB_SLP-RSP and MOB_TRF-IND messages, the subheader such as the sleep interval extended subheader, and the general data, all of which are used in the listening interval, to illustrate the existing operation. As for the mobile station that continues the sleep mode operation when it receives data in the listening interval, and then transitions back to the sleep interval upon expiration of the listening interval, the mobile station receives parameter values for sleep interval setting and applies the received parameter values to the sleep interval update algorithm.

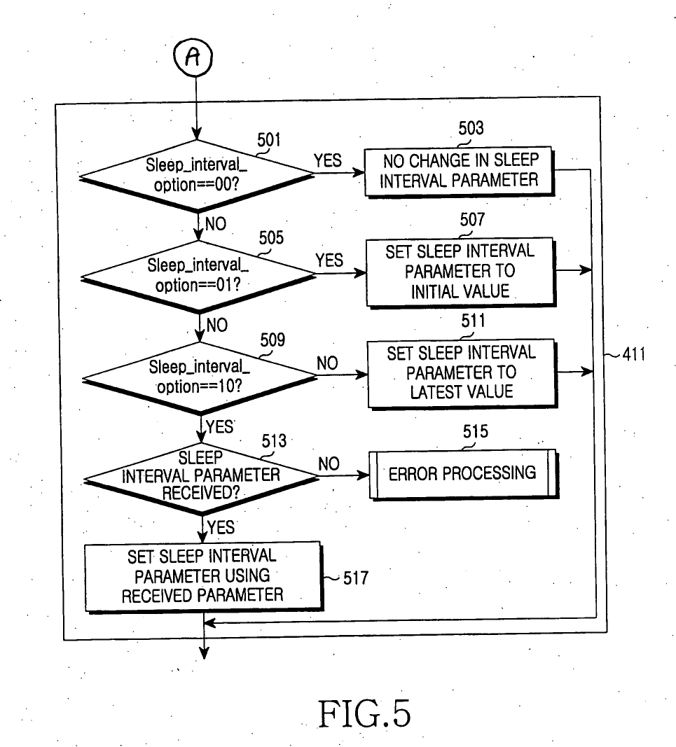

The operation of setting parameter values according to the ‘Sleep_interval_option’ in step 411 will be described in detail with reference to FIG. 5.

The flowchart shown in FIG. 5 corresponds to the detailed operation of step 411 in FIG. 4.

In step 501, the mobile station determines if a received ‘Sleep_interval_option’ is set to ‘00’. If so the mobile station proceeds to step 503 where it does not change the sleep interval parameters. However, if it is determined that the ‘Sleep_interval option’ is not set to ‘00’, the mobile station proceeds to step 505.

In step 505, the mobile station determines if the received ‘Sleep_interval option’ is set to ‘01’. If yes, the mobile station proceeds to step 507 where it sets the sleep interval parameters to initial values. The mobile station sets the sleep interval parameters to the initial values determined in MOB_SLP-REQ/RSP negotiation between the BS and the mobile station when entering the sleep mode. However, if it is determined that the ‘Sleep_interval_option’ is not set to ‘01’, the mobile station proceeds to step 509.

In step 509, the mobile station determines if the received ‘Sleep_interval_option’ is set to ‘10’. If yes, the mobile station proceeds to step 511. In this case, because ‘Sleep_interval_option’≠‘10’means ‘Sleep_interval_option’=‘11’, the mobile station sets in step 511 the sleep interval parameters to the latest values, i.e. fixes the current values. As a result, even though the sleep interval alternates with the listening interval, the mobile station keeps the current sleep window value. However, if it is determined that the ‘Sleep_interval_option’ is set to ‘10’, the mobile station proceeds to step 513.

In step 513, the mobile station determines if it has received sleep interval parameters based on the ‘Sleep_interval_option’. If it is determined that it has failed to receive the sleep interval parameters, the mobile station proceeds to step 515 where it performs error processing. However, if it is determined that it has received the sleep interval parameters, the mobile station proceeds to step 517.

In step 517, the mobile station sets a sleep interval using the received new sleep interval setting parameters. That is, the mobile station resets parameter values to the new values that it has received along with the ‘Sleep_interval_option’ related to the sleep interval and the listening interval, used for the sleep interval update algorithm.

With reference to Table 10, a description will now be made of a mobile station operation of setting sleep interval parameters according to the ‘Sleep_interval_option’.

TABLE 10

| Sleep_interval_option | Sleep Interval Parameters | Remarks |
|---|---|---|
| Sleep_interval_option == 00 | Initial-sleep window = current Initial-sleep | No change |
| | window; | in sleep |
| | Listening window = current Listening | interval |
| | window; | parameters |
| | Final-sleep window base = current Final- | |
| | sleep window | |
| | Final-sleep window exponent = current | |
| | Final-sleep window exponent; | |
| Sleep_interval_option = 01 | Initial-sleep window = initial Initial-sleep | sleep |
| | window; | interval |
| | Listening window = initial Listening | parameters |
| | window; | are set to |
| | Final-sleep window base = initial Final- | initial |
| | sleep window | values. |
| | Final-sleep window exponent = initial | |
| | Final-sleep window exponent; | |
| Sleep_interval_option == 10 | Initial-sleep window = new Initial-sleep | sleep |
| | window; | interval |
| | Listening window = new Listening | parameters |
| | window; | are set to |
| | Final-sleep window base = new Final- | new |
| | sleep window | values. |
| | Final-sleep window exponent = new | |
| | Final-sleep window exponent; | |
| Sleep_interval_option == 11 | Initial-sleep window = current Initial- | sleep |
| | sleep window; | interval |
| | Listening window = current Listening window; | parameters |
| | Final-sleep window base = current Final- | are set to |
| | sleep window | latest |
| | Final-sleep window exponent = current | values |
| | Final-sleep window exponent; | |

Table 10 shows the ‘Sleep_interval_option’-based sleep interval parameter setting operation shown in FIG. 5.

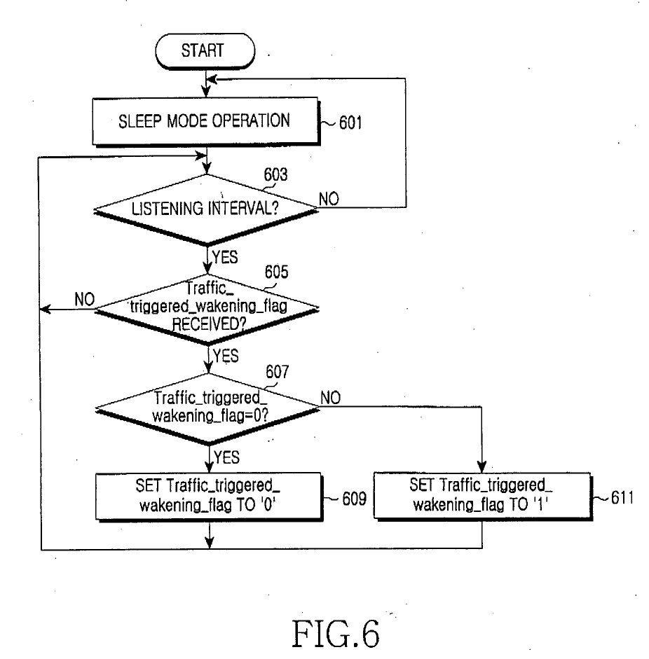

With reference to FIG. 6, a description will now be made of a mobile station operation of resetting ‘Traffic_triggered_wakening_flag’ in a listening interval.

Referring to FIG. 6, a mobile station performs a sleep mode operation in step 601, and then proceeds to step 603. The mobile station determines in step 603 if it is in a listening interval. If no, meaning that it is in a sleep interval, the mobile station returns to step 601 and continues the sleep mode operation. However, if it is determined that it is in the listening interval, the mobile station proceeds to step 605.

In step 605, the mobile station determines if it has received a new ‘Traffic_triggered_wakening_flag’. If it is determined that it has failed to receive a new ‘Traffic_triggered_wakening_flag’, the mobile station returns to step 603. However, if it is determined that it has received a new ‘Traffic_triggered_wakening_flag’, the mobile station proceeds to step 607.

In step 607, the mobile station determines if the received ‘Traffic_triggered_wakening_flag’ is set to ‘0’. If it is determined that the ‘Traffic_triggered_wakening_flag’ is not set to ‘0’ but to ‘1’, the mobile station proceeds to step 611.

In step 611, the mobile station sets the ‘Traffic_triggered_wakening_flag’ to ‘1’, and then returns to step 603. However, if it is determined that the ‘Traffic_triggered_wakening_flag’ is set to ‘0’, the mobile station proceeds to step 609 where it sets the ‘Traffic_triggered wakening_flag’ to ‘0’ and then returns to step 603.

As can be understood from the foregoing description, the present invention allows the wireless communication system to set a sleep interval through a sleep interval setting indicator, and applies a flag for determining activation/deactivation of the sleep mode. As a result, the system can set a sleep interval between a transmitter and a receiver using the sleep interval setting indicator, and can transmit sleep interval parameters when needed by the receiver, so that the receiver can set the sleep interval. In addition, the system can determine the sleep mode and activation/deactivation thereof using the flag for determining activation/deactivation of the sleep mode, and can adaptively operate according to a change in data traffic characteristics because it uses the flag. Further, as the system operates the sleep interval update algorithm using the sleep interval setting indicator and sleep interval parameters, it can efficiently cope with the characteristic change of the traffics for the mobile station without deactivating the sleep mode.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A method for controlling a sleep mode operation in a transmitter of a wireless communication system, the method comprising:
selecting a sleep interval setting indicator for controlling sleep interval parameter setting, if there is a need to set a sleep interval of a receiver; and
transmitting the selected sleep interval setting indicator to the receiver.

2. The method of claim 1, wherein the parameter includes at least one of an initial-sleep window, a listening window, a final-sleep window base, and a final-sleep window exponent.

3. The method of claim 1, wherein the sleep interval setting indicator includes an indicator for preventing a change in the sleep interval parameter.

4. The method of claim 1, wherein the sleep interval setting indicator includes an indicator for setting the sleep interval parameter to an initial value.

5. The method of claim 1, wherein the sleep interval setting indicator includes an indicator for fixing the sleep interval parameter to a current sleep window value.

6. The method of claim 1, wherein the sleep interval setting indicator includes an indicator for setting the sleep interval parameter using a new parameter.

7. The method of claim 6, further comprising:
transmitting a parameter for sleep interval setting to the receiver, if there is a need to transmit the parameter for sleep interval setting according to the sleep interval setting indicator.

8. The method of claim 1, further comprising:
transmitting to the receiver a flag value for determining a state of the sleep mode.

9. The method of claim 1, wherein the sleep interval setting indicator includes at least one of a sleep request message, a sleep response message, a traffic indication message, and a downlink (DL) sleep control extended subheader.

10. A method for performing a sleep mode operation in a receiver of a wireless communication system, the method comprising:
receiving from a transmitter a sleep interval setting indicator for controlling sleep interval parameter setting; and
setting a sleep interval parameter according to the sleep interval setting indicator.

11. The method of claim 10, wherein the parameter includes at least one of an initial-sleep window, a listening window, a final-sleep window base, and a final-sleep window exponent.

12. The method of claim 10, wherein the sleep interval setting indicator includes an indicator for preventing a change in the sleep interval parameter.

13. The method of claim 10, wherein the sleep interval setting indicator includes an indicator for setting the sleep interval parameter to an initial value.

14. The method of claim 10, wherein the sleep interval setting indicator includes an indicator for fixing the sleep interval parameter to a current sleep window value.

15. The method of claim 10, wherein the sleep interval setting indicator includes an indicator for setting the sleep interval parameter using a new parameter.

16. The method of claim 15, further comprising:
receiving from the transmitter a parameter for sleep interval setting, if there is a need to receive the parameter for sleep interval setting according to the sleep interval setting indicator; and
setting a sleep interval using the parameter for sleep interval setting.

17. The method of claim 10, wherein the sleep interval setting indicator includes at least one of a sleep request message, a sleep response message, a traffic indication message, and a downlink (DL) sleep control extended subheader.

18. A system for performing a sleep mode operation in a wireless communication system, the system comprising:
a transmitter for selecting a sleep interval setting indicator for controlling sleep interval parameter setting, if there is a need to set a sleep interval of a receiver, and transmitting the selected sleep interval setting indicator to the receiver.

19. The system of claim 18, wherein the parameter includes at least one of an initial-sleep window, a listening window, a final-sleep window base, and a final-sleep window exponent.

20. The system of claim 18, wherein the sleep interval setting indicator includes an indicator for preventing a change in the sleep interval parameter.

21. The system of claim 18, wherein the sleep interval setting indicator includes an indicator for setting the sleep interval parameter to an initial value.

22. The system of claim 18, wherein the sleep interval setting indicator includes an indicator for fixing the sleep interval parameter to a current sleep window value.

23. The system of claim 18, wherein the sleep interval setting indicator includes an indicator for setting the sleep interval parameter using a new parameter.

24. The system of claim 23, wherein the transmitter transmits a parameter for sleep interval setting to the receiver, if there is a need to transmit the parameter for sleep interval setting according to the sleep interval setting indicator.

25. The system of claim 18, wherein the transmitter transmits to the receiver a flag value for determining a state of the sleep mode.

26. The system of claim 18, wherein the transmitter transmits the sleep interval setting indicator using at least one of a sleep request message, a sleep response message, a traffic indication message, and a downlink (DL) sleep control extended subheader.

27. A system for performing a sleep mode operation in a wireless communication system, the system comprising:
a receiver for receiving from a transmitter a sleep interval setting indicator for controlling sleep interval parameter setting, and setting a sleep interval parameter according to the sleep interval setting indicator.

28. The system of claim 27, wherein the parameter includes at least one of an initial-sleep window, a listening window, a final-sleep window base, and a final-sleep window exponent.

29. The system of claim 27, wherein the sleep interval setting indicator includes an indicator for preventing a change in the sleep interval parameter.

30. The system of claim 27, wherein the sleep interval setting indicator includes an indicator for setting the sleep interval parameter to an initial value.

31. The system of claim 27, wherein the sleep interval setting indicator includes an indicator for fixing the sleep interval parameter to a current sleep window value.

32. The system of claim 27, wherein the sleep interval setting indicator includes an indicator for setting the sleep interval parameter using a new parameter.

33. The system of claim 32, wherein the receiver receives from the transmitter a parameter for sleep interval setting, if there is a need to receive the parameter for sleep interval setting according to the sleep interval setting indicator, and sets a sleep interval using the parameter for sleep interval setting.

34. The system of claim 27, wherein the receiver receives the sleep interval setting indicator using at least one of a sleep request message, a sleep response message, a traffic indication message, and a downlink (DL) sleep control extended subheader.
